(19) United States
(12) Patent Application Publication
(10) Pub. No.: US 2025/0207288 A1
(43) Pub. Date: Jun. 26, 2025

(54) COATING FOR POROUS SUBSTRATE

(71) Applicant: SAFRAN CERAMICS, Le Haillan (FR)

(72) Inventors: Lisa PIN, Moissy-Cramayel (FR); Camille LE BRETON, Moissy-Cramayel (FR)

(73) Assignee: SAFRAN CERAMICS, Le Haillan (FR)

(21) Appl. No.: 18/847,096

(22) PCT Filed: Feb. 23, 2023
(86) PCT No.: PCT/FR2023/050255

§ 371 Date: Sep. 13, 2024

(30) Foreign Application Priority Data
Mar. 16, 2022 (FR) 2202296

(51) Int. Cl. C25D 13/02; B64C 25/42; C25D 13/12; C25D 13/18; C25D 15/00

(52) U.S. Cl. CPC C25D 13/02; B64C 25/42; C25D 13/12; C25D 13/18; C25D 15/00

(57) ABSTRACT

A method for manufacturing a coating for a porous substrate, and to a mechanical part equipped with such a coating, the method including the following steps: providing a substrate to be protected, the substrate containing pores; providing a liquid suspension containing at least a first powder and a second powder, the first powder possessing a D50 strictly smaller than that of the second powder and an electrophoretic mobility strictly higher than that of the second powder; providing a DC electric generator; placing the substrate in the suspension, as a first electrode, and connecting the substrate to a first terminal of the electric generator; placing a second electrode in the suspension and connecting the second electrode to a second terminal of the electric generator; and applying a continuous or pulsed voltage of at least 10 V across the two electrodes for at least 1 minute.

### TECHNICAL FIELD

The present disclosure relates to a method for manufacturing a coating for a porous substrate, and to a mechanical part equipped with such a coating. This method is applicable for any type of porous substrate. However, it is particularly adapted for parts made of C/C (carbon/carbon) composite material, particularly those subject to strong heating, such as brakes, and exposed to particularly oxidizing environments, particularly in the aeronautical field.

### PRIOR ART

Thanks to their excellent tribological properties and their lightness, C/C composite materials have now established themselves as the reference material for aeronautical braking.

However, due to the very significant heating undergone by the C/C brakes, which can exceed 1400° C. and sometimes even reach 2000° C., the carbon constituting these brakes is subject to oxidation phenomena by the ambient air, which significantly reduces the lifespan of these C/C brakes.

In order to combat these oxidation phenomena, anti-oxidation protective coatings are conventionally applied to the non-friction portions of C/C brakes, that is to say to the portions exposed to the oxygen in the air.

However, due to the great variability of the oxidizing conditions that such C/C brakes can encounter, depending on the temperature levels, the operating times, or else the chemical elements of the environment, in particular the presence of water, it is generally necessary to combine two protective mechanisms. The first aims at trapping carbon oxidation catalysts, such as potassium acetate coming in particular from de-icing products used on landing strips. The second aims at reducing the speed of diffusion of oxygen towards the carbon substrate.

Conventionally, these two protective mechanisms are the subject of distinct layers. Indeed, anti-catalytic protection is generally obtained by applying a precursor to the surfaces to be protected, using a gun, a precursor which must then undergo a transformation requiring a temperature below 1000° C. Conversely, anti-diffusion protection is generally obtained by deposition methods at high temperatures, above 1000° C.

However, as shown in FIG. 1, the conventional method for depositing anti-catalytic protection leads to the formation of discontinuous islands of active ingredient 91, here alumino-phosphate Al(PO₃)₃, leaving areas of the substrate 92 exposed, the precursor Al(H₂PO₄)₃ indeed including a share of water which evaporates during its transformation: the layer thus obtained, which is discontinuous, cannot therefore play the role of barrier against the diffusion of oxygen towards the substrate.

Therefore, it is generally necessary to multiply the deposition and stabilization steps in order to obtain multilayer anti-oxidation protection which has the desired level of effectiveness. This conventional method therefore showed numerous constraints.

Consequently, a new deposition method implementing the electrophoresis technique was proposed in application FR 21/11927. This new method has shown very good results for forming a single-layer protective coating: indeed, as shown in FIG. 2, the coating 93 obtained is dense and continuous, which allows to effectively protect the substrate 94, at least as long as the coating is intact.

However, as visible in FIG. 2, this method only allows to form an external layer on the surface of the substrate: in particular, it is observed that the coating 93 does not penetrate at all into the pores 95 of the substrate 94. Consequently, the substrate 94 is vulnerable in the event of scratching or chipping of the coating 93: indeed, in such a case, oxidizing or corrosive agents from the environment can penetrate deep into the substrate 94 through the defect in the coating 93 then through the array of pores 95, which can lead to corrosion of the substrate 94 under the coating 93.

There is therefore a real need for a method for manufacturing a coating for a porous substrate, and a mechanical part equipped with such a coating, which are devoid, at least partly, of the disadvantages inherent in the aforementioned known methods.

### DISCLOSURE OF THE INVENTION

The present disclosure relates to a method for manufacturing a coating for a porous substrate, comprising the following steps:
providing a substrate to be protected, the substrate containing pores,
providing a liquid suspension containing at least a first powder and a second powder, the first powder possessing a D50 strictly smaller than that of the second powder and an electrophoretic mobility strictly greater than that of the second powder,
providing a DC electric generator,
placing the substrate in the suspension, as a first electrode, and connecting the substrate to a first terminal of the electric generator,
placing a second electrode in the suspension and connecting the second electrode to a second terminal of the electric generator, and
applying a continuous or pulsed voltage of at least 10 V across the two electrodes for at least 1 minute.

By using a liquid suspension of two powders having different sizes and electrophoretic mobilities, it is possible, using such an electrophoresis method, to form a double-layer coating in which the particles of the finest powder penetrate deep into the pores of the substrate, forming an internal layer, while the particles of the coarsest powder are deposited on the surface of the substrate, forming an external layer.

Thanks to a higher electrophoretic mobility, the first powder reaches the substrate more quickly than the second powder, which allows it to penetrate into the pores of the substrate before the latter are covered on the surface by the particles of the second powder.

This method thus allows to obtain in a single step a double-layer coating fulfilling at least two functions. It is thus possible to form, on the one hand, a continuous external layer over the entire surface of the substrate immersed in the suspension, with a density sufficient to form an effective barrier, for example against the diffusion of oxygen, and, on the other hand, an internal layer filling at least partly the pores of the substrate so as to form a second barrier preventing, in the event of rupture of the external layer, the penetration of elements from the environment within the array of pores.

Thanks to this method, it is possible, if necessary, to include several different active ingredients in the suspension in order to provide the coating with additional functions without multiplying the layers and therefore without multiplying the manufacturing costs and without being limited by differential expansion problems. It is in particular possible to choose one or more different active ingredients for each powder in order to provide the outer layer and the inner layer with different properties. That said, the two powders can also have the same chemical composition.

In addition, the use of electrophoresis allows to form this coating from a liquid suspension directly comprising the active ingredient(s), and not a precursor as was the case in certain previous methods. Likewise, since the active ingredient can be deposited directly and uniformly on the substrate, it is possible to form a layer as thick as desired in a single electrophoresis step, without resorting to intermediate stabilization steps. This also helps reduce the cycle time.

In the present disclosure, the characteristic diameters of the powders, in particular D10, D50 and D90, are determined by laser diffraction.

In certain embodiments, the D90 of the first powder is strictly smaller than the D10 of the second powder. This ensures a significant difference in size between the two powders, which reduces the risk that particles of the first powder remain blocked on the surface of the substrate or, conversely, that particles of the second powder do not penetrate into the pores of the substrate.

In certain embodiments, the D50 of the first powder is strictly smaller than the average diameter of the pores of the substrate. Preferably, the D50 of the first powder is smaller than or equal to 50%, more preferably 10% or 5%, of the average diameter of the pores of the substrate. This allows good penetration of the particles of the first powder into the pores of the substrate.

In certain embodiments, the D50 of the first powder is smaller than or equal to 0.5 μm, preferably smaller than or equal to 0.2 μm.

In certain embodiments, the D90 of the first powder is smaller than or equal to 1 μm, preferably smaller than or equal to 0.5 μm.

In certain embodiments, the D50 of the second powder is strictly larger than the average diameter of the pores of the substrate. Preferably, the D50 of the second powder is larger than or equal to 150%, more preferably 200%, of the average diameter of the pores of the substrate. This reduces the risk of particles of the second powder penetrating the pores of the substrate.

In certain embodiments, the D50 of the second powder is larger than or equal to 0.5 μm, preferably larger than or equal to 2 μm.

In certain embodiments, the D50 of the second powder is smaller than or equal to 5 μm, preferably smaller than or equal to 2 μm. This reduces the risk of sedimentation of the second powder in the liquid suspension. In particular, the D50 of the second powder can be comprised between 0.5 and 2 μm.

In certain embodiments, the D10 of the second powder is larger than or equal to 0.5 μm, preferably larger than or equal to 1 μm.

In certain embodiments, the D50 of the second powder is smaller than or equal to 5 μm.

In certain embodiments, the electrophoretic mobility of the first powder is at least 25% higher, preferably at least 50% higher, than that of the second powder. Such a gap allows to reduce the risk that a too large amount of particles of the second powder reaches the substrate before the particles of the first powder.

In certain embodiments, the electrophoretic mobility of the first powder is higher than or equal to 0.5 m²/Vs, preferably higher than or equal to 0.7 m²/Vs.

In certain embodiments, the electrophoretic mobility of the first powder is less than or equal to 2 m²/Vs.

In certain embodiments, the electrophoretic mobility of the second powder is less than or equal to 0.5 m²/Vs, preferably less than or equal to 0.3 m²/Vs.

In certain embodiments, the electrophoretic mobility of the second powder is higher than or equal to 0.3 m²/Vs.

In certain embodiments, the method comprises, before the step of providing the liquid suspension, a step of treating the first powder resulting in the ionization of the surface of the particles of the first powder. Such ionization allows to artificially increase the electrophoretic mobility of the first powder.

In certain embodiments, the concentration, by mass, of the first powder is greater than that of the second powder. Indeed, as the particle size of the first powder is smaller than the second, it is preferable to compensate for this difference in size with a higher concentration, for example approximately twice as high.

In certain embodiments, the particles of the first powder penetrate into the pores of the substrate at least over 1 mm, preferably at least over 2 mm, forming an internal coating layer.

In certain embodiments, the particles of the first powder penetrate into the pores of the substrate no more than 5 mm, preferably no more than 3 mm.

In certain embodiments, the method further comprises, after the voltage application step, a heat treatment step resulting in the crystallization of the particles of the first powder. Such crystallization causes an expansion of the material of the first powder, which allows to more effectively seal the pores of the substrate within the internal layer of the coating.

In certain embodiments, the particles of the second powder are deposited on the surface of the substrate, without penetrating into the pores of the substrate, forming an external coating layer having a thickness greater than or equal to 10 μm, preferably greater than or equal to 50 μm.

In certain embodiments, the thickness of the external coating layer is comprised between 10 and 300 μm, preferably between 50 and 150 μm. Such thickness ranges allow to effectively restrict the diffusion of oxygen within the coating.

In certain embodiments, the coating obtained has a surface mass comprised between 10 and 50 mg/cm², preferably between 20 and 40 mg/cm². Such density ranges allow to effectively restrict the diffusion of oxygen within the coating.

In certain embodiments, the substrate is made of C/C composite material.

In certain embodiments, at least the first powder or the second powder comprises an active ingredient from the phosphate family. Phosphates allow to trap carbon oxidation catalysts. It is thus possible to obtain dual anti-oxidation protection, having both an anti-catalytic function and a diffusion barrier function.

In certain embodiments, the first powder comprises a monoaluminum phosphate precursor, silica, alumina, or aluminophosphate. In particular, the aluminophosphate of formula Al(PO₃)₃ offers very good anti-catalytic properties.

In certain embodiments, the second powder comprises borosilicates with fluxing agents such as boron. This allows to form a protective glass layer during heat treatment. This second powder may also contain a monoaluminum phosphate precursor, silica, alumina or aluminophosphate, in particular, aluminophosphate of formula Al(PO₃)₃.

In certain embodiments, the liquid phase of the suspension comprises 1-propanol and/or 2-propanol. All of these two species can in particular constitute at least 90% of the liquid phase, or even 100% of the liquid phase. In particular, 1-propanol and 2-propanol can be present in equal shares in the liquid phase.

In certain embodiments, the liquid phase of the suspension consists of a 50/50 mixture of 1-propanol and/or 2-propanol.

In certain embodiments, the suspension comprises a stabilizer. This stabilizer allows to reduce the sedimentation speed of suspended particles, by the effect of steric or electrostatic repulsion between the particles.

In certain embodiments, the stabilizer comprises phosphoric acid. Preferably, the stabilizer is exclusively phosphoric acid.

In certain embodiments, the concentration of stabilizer in the suspension is comprised between 1 and 10 g/L, preferably between 2 and 8 g/L, more preferably between 3 and 5 g/L.

In certain embodiments, the distance separating the electrodes is comprised between 5 and 50 mm.

In certain embodiments, the voltage applied across the electrodes is comprised between 10 and 200 V, preferably between 30 and 80 V, more preferably between 40 and 60 V.

In certain embodiments, the voltage applied across the electrodes is a continuous voltage.

In other embodiments, the voltage applied across the electrodes is a pulsed voltage. The inventors have discovered that pulsed voltage allows better infiltration of the suspension for the same overall duration. The pulsation frequency is for example comprised between 1 Hz and 10 kHz, preferably between 1 Hz and 100 Hz.

In certain embodiments, the phase during which the voltage is applied (high state and low state for a pulsed voltage) has a duration comprised between 1 and 30 minutes, preferably between 1 and 10 minutes.

The present description also relates to a mechanical part, comprising a substrate, containing pores and having a surface to be protected, and a continuous and waterproof coating, including
an internal coating layer, extending under the surface to be protected and sealing the pores of the substrate over at least 2 mm, and
an external coating layer, extending over the surface to be protected over at least 10 μm.

This mechanical part therefore benefits from a double-layer coating capable of protecting the part on the surface and in depth. This coating can in particular be obtained using a manufacturing method according to any one of the preceding embodiments. Therefore, this results in all the advantages mentioned above regarding the method. In particular, all the optional characteristics of the method, and all the advantages associated therewith, can be transposed directly to the mechanical part.

In certain embodiments, the substrate is made of C/C composite material and the coating is an anti-oxidation protection comprising an active ingredient from the phosphate family. The part thus benefits from anti-oxidation protection having both the anti-catalytic function and the diffusion barrier function.

The present disclosure also relates to a brake for an aircraft, comprising a mechanical part according to any one of the preceding embodiments. The brake can then have both a relatively low mass and good resistance to oxidation, including at high temperatures.

The aforementioned characteristics and advantages, as well as others, will appear upon reading the detailed description which follows, of examples of the method and the mechanical part proposed. This detailed description refers to the appended drawings.

### BRIEF DESCRIPTION OF THE DRAWINGS

The appended drawings are schematic and aim above all at illustrating the principles of the description.

In these drawings, from one figure to another, identical elements (or portions of elements) are identified by the same reference signs.

FIG. 1 is a micrograph of an anti-corrosion coating according to a first prior art.

FIG. 2 is a micrograph of an anti-corrosion coating according to a second prior art.

FIG. 3 is a schematic diagram of the electrophoresis step.

FIG. 4 represents a liquid suspension in the context of an exemplary embodiment.

FIG. 5 represents an electrophoresis installation according to the context of the exemplary embodiment.

FIG. 6 represents the same electrophoresis installation at the end of the electrophoresis step.

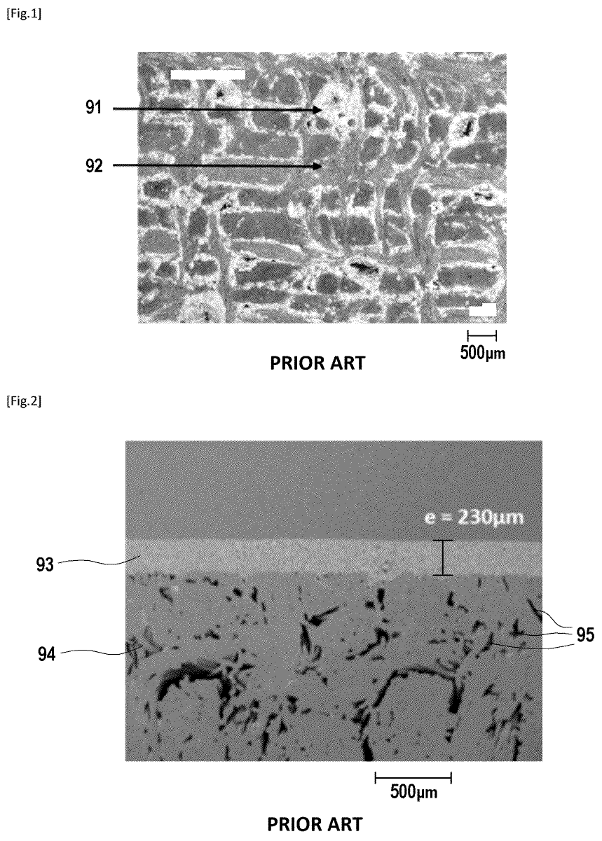

### DESCRIPTION OF EMBODIMENTS

In order to make the presentation more concrete, an example of a coating manufacturing method is described in detail below, with reference to the appended drawings. It is recalled that the invention is not limited to this example.

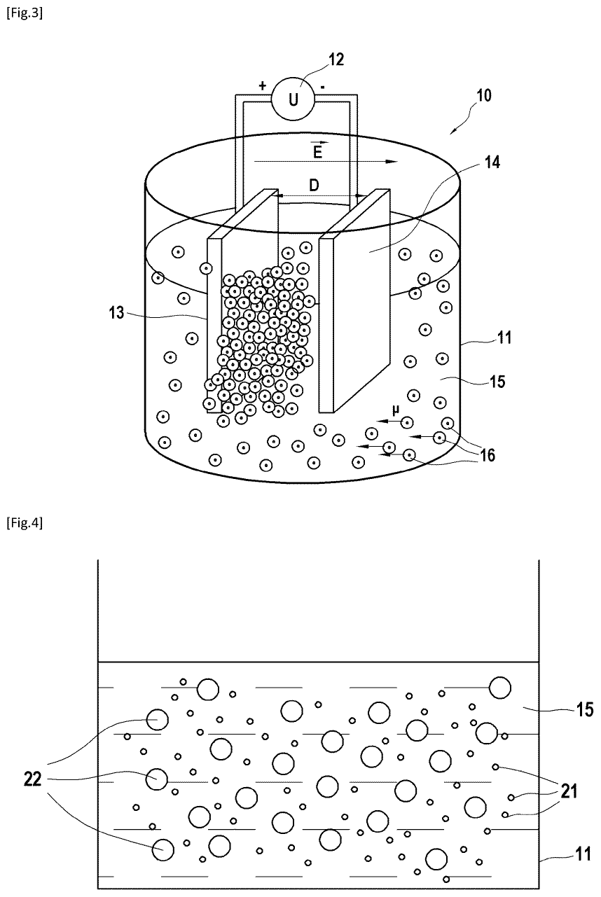

FIG. 3 schematically shows an electrophoresis device 10 involved in the method which will be described below. It comprises a tank 11, a DC electric generator 12, a first electrode 13, connected to the positive terminal of the electric generator 12, and a second electrode 14, connected to the negative terminal of the electric generator 12. The tank 11 is filled with a suspension 15 comprising particles 16 suspended in a liquid phase. The two electrodes 13 and 14 are immersed in the suspension 15. They preferably face each other, parallel to each other. A distance D separates the two electrodes 13 and 14.

When the electric generator 12 applies a voltage U across the two electrodes 13, 14, an electric field E passes through the suspension 15 and causes the particles 16 to migrate towards one or the other of the electrodes 13, 14 depending on their electric charge. Thus, the particles 16 here carrying a negative electric charge migrate towards the positive electrode 13 and are deposited thereon. The speed of migration of particles 16 depends on the intensity of the electric field E and the electrophoretic mobility μ of the particles 16: for a given electric field E, the higher the electrophoretic mobility μ of the particle 16, the more particle 16 will migrate quickly towards the electrode of opposite charge, according to the following formula: v=μ×E.

The amount of material deposited on the electrode 13 can then be expressed using Hamaker's law: Δm=A/D×μ×E×C×Δt, with
A, the surface of the electrode 13,
D, the distance between the electrodes 13, 14,
μ, the electrophoretic mobility of the particles 16,
E, the imposed electric field,
C, the concentration of the particles 16 in the suspension 15,
Δt, the duration of the electrophoresis step.

An example of a coating manufacturing method will now be described in more detail. In this example, the suspension 15, shown in FIG. 4, consists of:
a 50/50 mixture of 1-propanol and 2-propanol, constituting the liquid phase of the suspension,
65% by mass of Al(PO₃)₃, in the form of a first powder 21 possessing a D50 equal to 0.2 μm, suspended in the liquid phase,
35% by mass of borosilicate and boron (90/10), in the form of a second powder 22 possessing a D50 equal to 2 μm, suspended in the liquid phase, and
4 g/L of phosphoric acid, acting as a stabilizer, in solution in the liquid phase.

The electrophoretic mobility of the first powder is equal to 0.6 m²/Vs while the electrophoretic mobility of the second powder is equal to 0.3 m²/Vs.

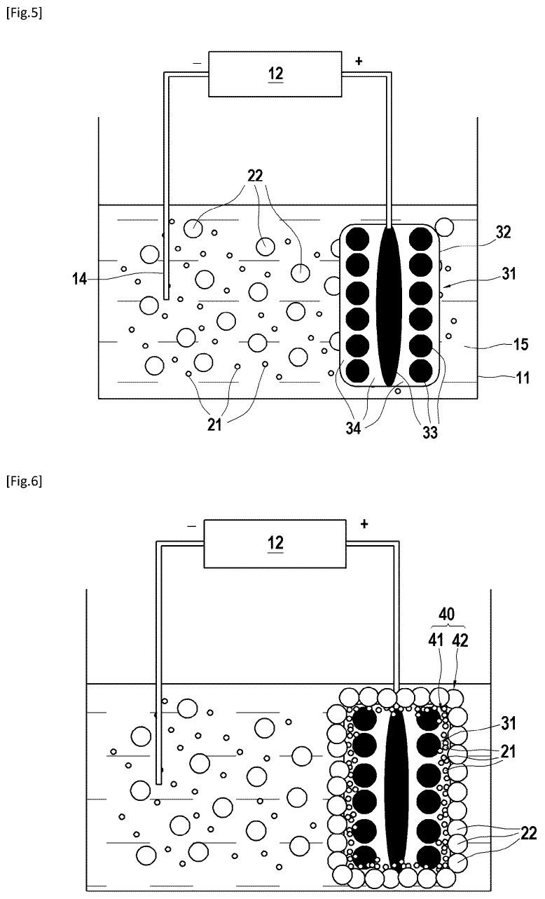

In the present example, the substrate to be protected 31 is a C/C (carbon/carbon) composite substrate containing pores whose average diameter is of the order of 10 μm. FIG. 5 schematically shows the substrate 31 with its peripheral surface 32, areas of material 33 and its pores 34 (white areas forming the interstices between the areas of material 33).

The substrate 31 is thus immersed in the liquid suspension 15 and connected to the positive terminal of the generator 12: the substrate 31 being made of C/C composite material, it is conductive and can therefore constitute such an electrode. A counter-electrode 14 is also immersed in the liquid suspension 15 and connected to the negative terminal of the generator 12.

The substrate 31 and the counter-electrode 14 are then separated by a distance D comprised between 5 and 50 mm, this distance being variable due to the geometry of the part to be coated, and the electric generator 12 applies a voltage U of 50 V across its terminals.

This voltage U is maintained for 5 minutes. During this electrophoresis step, as can be seen in FIG. 6, the particles of the first powder 21 migrate more quickly towards the substrate 31 due to their higher electrophoretic mobility and, thanks to their diameter smaller than the average diameter of the pores 34 of the substrate 31, penetrate into the pores 34 at which they are deposited, gradually forming an internal layer 41. The particles of the second powder 22, which are slower, reach the substrate with a lower flow rate and, being too large to penetrate into the pores 34, are deposited on the surface 32 of the substrate 31, gradually forming an external layer 42.

The speed of formation of the outer layer 42 being lower than that of the internal layer 41, the particles of the first powder 21 have time to fill substantially all the pores 34 located under the surface 32 of the substrate 31, to a depth between 2 and 3 mm, before the external layer 42 blocks the pores 34 on the surface.

After this electrophoresis step, the substrate 21, now carrying an internal layer 41 of Al(PO₃)₃ particles and an external layer 42 of borosilicate particles (the boron serving as a fluxing agent having volatilized), is removed from the tank 11 and undergoes a stabilization step carried out at 700° C. for 1 hour to 5 hours in a nitrogen atmosphere. It allows to consolidate the protective layers 41, 42 thus obtained, thus forming a protective coating 40. In particular, this step allows to crystallize the particles 21 of the internal layer 41 and, thus, to fill the pores 34 of the internal layer 41.

Although the present invention has been described with reference to specific embodiments, it is evident that modifications and changes can be made to these examples without departing from the general scope of the invention as defined by the claims. In particular, individual features of the different illustrated/mentioned embodiments can be combined in additional embodiments. Consequently, the description and drawings should be considered in an illustrative rather than a restrictive sense.

It is also obvious that all the characteristics described with reference to a method can be transposed, alone or in combination, to a device, and conversely, all the characteristics described with reference to a device can be transposed, alone or in combination, to a method.

1. A method for manufacturing a coating for a porous substrate, comprising the following steps:
providing a substrate to be protected, the substrate containing pores,
providing a liquid suspension containing at least a first powder and a second powder, the first powder possessing a D50 strictly smaller than that of the second powder and an electrophoretic mobility at least 25% higher than that of the second powder,
providing a DC electric generator,
placing the substrate in the suspension, as a first electrode, and connecting the substrate to a first terminal of the electric generator,
placing a second electrode in the suspension and connecting the second electrode to a second terminal of the electric generator, and
applying a continuous or pulsed voltage of at least 10 V across the two electrodes for at least 1 minute.

2. The method according to claim 1, wherein the D90 of the first powder is strictly smaller than the D10 of the second powder.

3. The method according to claim 1, wherein the D50 of the first powder is smaller than or equal to 0.5 μm, and
wherein the D50 of the second powder is larger than or equal to 0.5 μm.

4. The method according to claim 1, wherein the electrophoretic mobility of the first powder is at least 50% higher than that of the second powder.

5. The method according to claim 1, wherein the electrophoretic mobility of the first powder is higher than or equal to 0.5 m²/Vs, and
wherein the electrophoretic mobility of the second powder is less than or equal to 0.5 m²/Vs.

6. The method according to claim 1, wherein the concentration, by mass, of the first powder is greater than that of the second powder.

7. The method according to claim 1, wherein the particles of the first powder penetrate into the pores of the substrate at least over 1 mm, preferably at least over 2 mm, forming an internal coating layer, and
wherein the particles of the second powder are deposited on the surface of the substrate, without penetrating into the pores of the substrate, forming an external coating layer having a thickness greater than or equal to 10 μm.

8. The method according to claim 7, wherein the particles of the first powder penetrate into the pores of the substrate no more than 5 mm.

9. The method according to claim 1, wherein the substrate is a C/C composite substrate.

10. The method according to claim 1, wherein the first powder comprises a monoaluminum phosphate precursor, silica, alumina or aluminophosphate, and
wherein the second powder comprises borosilicates with fluxing agents such as boron.

11. A mechanical part, comprising a substrate, containing pores and having a surface to be protected, and a continuous and waterproof coating, including
an internal coating layer, formed by particles of a first powder, extending under the surface to be protected and sealing the pores of the substrate over at least 2 mm, and
an external coating layer, formed by particles of a second powder, extending over the surface to be protected over at least 10 μm, the first powder possessing a D50 strictly smaller than that of the second powder.

12. The mechanical part according to claim 11, wherein the coating is an anti-oxidation protection comprising an active ingredient from the phosphate family.

13. A brake for an aircraft, comprising a mechanical part according to claim 11.
